(19) United States
(12) Patent Application Publication
(10) Pub. No.: US 2016/0272123 A1
(43) Pub. Date: Sep. 22, 2016

(54) LUGGAGE CARRIER CROSS RAIL DOCKING STATIONS

(71) Applicant: GM GLOBAL TECHNOLOGY OPERATIONS LLC, Detroit, MI (US)

(72) Inventors: JOEL T. BACHLER, Rochester, MI (US); SCOTT D. SUTHERLAND, Rochester, MI (US); JEFFREY A. DIEGEL, South Lyon, MI (US); MARK A. FREDAL, Sterling Heights, MI (US); BRIAN J. JUTILA, Richmond, MI (US); RICHARD C. SPINA, Bloomfield Hills, MI (US)

(21) Appl. No.: 14/664,207

(22) Filed: Mar. 20, 2015

(51) Int. Cl. B60R 9/058

(52) U.S. Cl. CPC B60R 9/058; B60R 2011/004

(57) ABSTRACT

A number of variations may include a luggage carrier system that may include a plurality of docking pads and at least one cross-rail wherein each individual docking pad may include a first surface and a second surface opposite the first surface and a protuberant that may extend from the second surface and may define a threaded hole constructed and arranged to receive a cross-rail bolt. The at least one cross-rail may include a rail having a first end and a second end, a first stanchion affixed to the first end, a second stanchion affixed to the second end, and may be constructed and arranged to be removably attached to the plurality of docking pads via the cross-rail bolt.

### TECHNICAL FIELD

The field to which the disclosure generally relates includes luggage carriers for automobiles.

### BACKGROUND

Luggage carriers used on vehicles may include fixed, permanent cross-rails designed to support the weight of cargo carried by a vehicle.

### SUMMARY OF ILLUSTRATIVE VARIATIONS

A number of variations may include a product that may include a luggage carrier system that may include a plurality of docking pads and at least one cross-rail wherein each individual docking pad may include a first surface and a second surface opposite the first surface and a protuberant that may extend from the second surface and may define a threaded hole constructed and arranged to receive a cross-rail bolt. The at least one cross-rail may include a rail having a first end and a second end, a first stanchion affixed to the first end, a second stanchion affixed to the second end, and may be constructed and arranged to be removably attached to the plurality of docking pads via the cross-rail bolt.

A number of variations may also include a vehicle that may include a roof that may include a plurality of roof recesses. A plurality of docking pads may be disposed within the plurality of roof recesses wherein each individual docking pad may include a first surface and a second surface opposite the first surface and a protuberant extending from the second surface which may define a threaded hole constructed and arranged to receive a cross-rail bolt. The at least one cross-rail may include a rail that may have a first end and a second end, a first stanchion affixed to the first end, a second stanchion affixed to the second end, and may be constructed and arranged to be removably attached to the plurality of docking pads via the cross-rail bolt.

A number of variations may also include a vehicle that may include a roof that may include a plurality of roof recesses. A plurality of docking pads may be disposed within the plurality of roof recesses wherein each individual docking pad may include a first surface and a second surface opposite the first surface and a recess portion may extend from the second surface and may define a threaded hole constructed and arranged to receive a cross-rail bolt and wherein the plurality of docking pads may include a first docking pad and a second docking pad, the first docking pad being constructed and arranged to receive a first stanchion and the second docking pad being constructed and arranged to receive a second stanchion. At least one cross-rail may include a rail having a first end and a second end, a first stanchion affixed to the first end, a second stanchion affixed to the second end, and may be constructed and arranged to be removably attached to the plurality of docking pads via the cross-rail bolt and wherein the first and second docking pads may include a corresponding first and second alignment feature defined by the first surface and the first and second stanchions may include a third and fourth alignment feature corresponding to the first and second alignment feature such that when the first and second docking pads receive the first and second stanchions, the first and third alignment feature may interlock and the second and fourth alignment feature may interlock.

Other illustrative variations within the scope of the invention will become apparent from the detailed description provided hereinafter. It should be understood that the detailed description and enumerated variations, while disclosing optional variations, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts one variation of a luggage carrier cross rail docking station;

FIG. 2 depicts one variation of a docking pad;

FIG. 3 depicts one variation of a luggage carrier cross rail docking system;

FIG. 4A depicts one variation of a luggage carrier cross rail docking system; and

FIG. 4B depicts one variation of a cross-section luggage carrier cross rail docking system.

### DETAILED DESCRIPTION OF ILLUSTRATIVE VARIATIONS

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are considered to be within the scope of the invention.

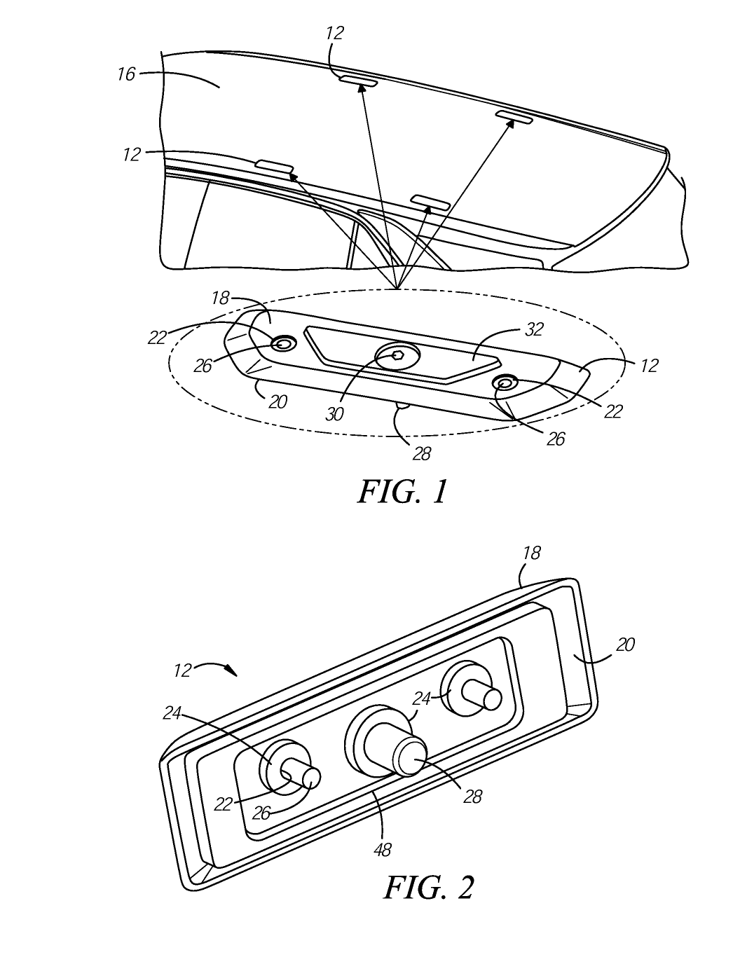

Referring to FIG. 1; a vehicle 16 may include a plurality of docking pads 12 disposed on the roof or other surface of the vehicle 16. Each individual dock of the plurality of docking pads 12 may include a first surface 18 and second surface 20. A plurality of through holes 22 may be defined by the plurality of docking pads 12. A plurality of studs 26 may affix the plurality of docking pads 12 to the vehicle 16. The plurality of docking pads 12 may define a protuberant 28 (or stud anchor) extending from the second surface 20, which may define a threaded hole 34 for receiving a cross-rail bolt 30. The plurality of docking pads 12 may also define an alignment feature 32 that may be a depression or protuberant on the first surface 18. The alignment feature 32 may be constructed and arranged to facilitate the attachment of a cross-rail 14.

Referring now to FIG. 2; a plurality of docking pads 12 may include a first surface 18, a second surface 20, a plurality of through holes 22, and a protuberant 28 extending from the second surface 20 defining a threaded hole 34. A plurality of studs 26 may be disposed within the plurality of through holes 22 which may facilitate attachment of the plurality of docking pads 12 to a vehicle 16. A plurality of gaskets 24 may be disposed on the second surface 20 such that they surround the protuberant 28 and the plurality of studs 26. A primary gasket 48 may surround the perimeter of the second surface 20 of the plurality of docking pads 12.

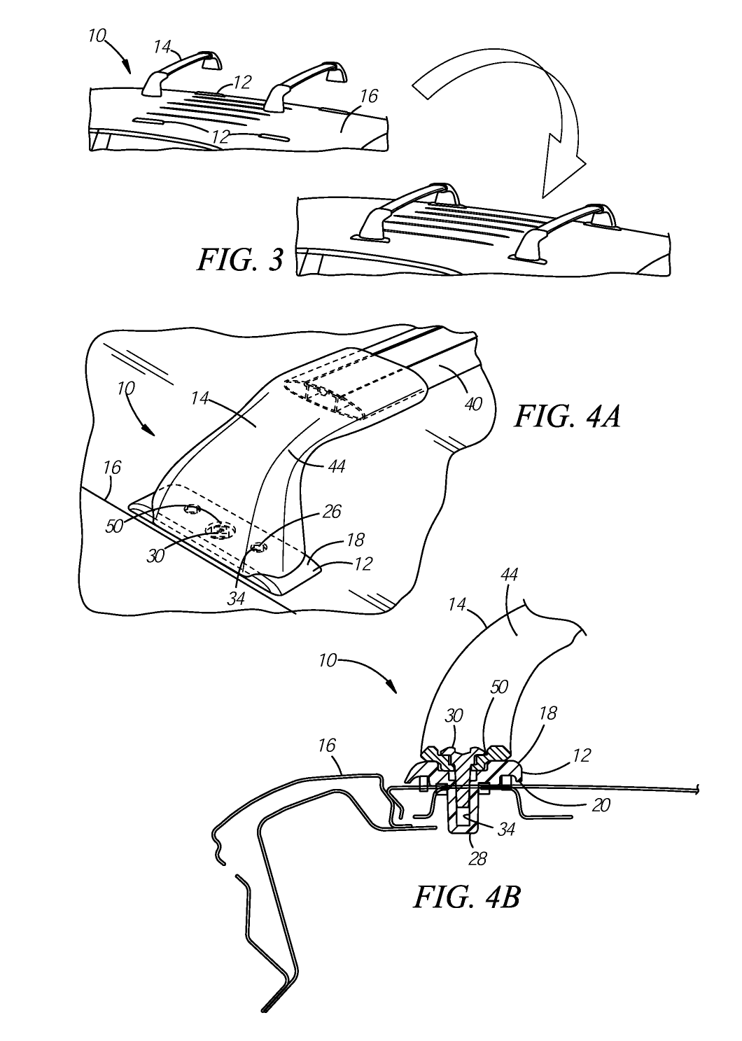

Referring now to FIG. 3; a luggage carrier 10 may include a plurality of docking pads 12 disposed on a surface of a vehicle 16 constructed and arranged to attach a plurality of cross-rails 14 to the vehicle 16. Similarly, the plurality of cross-rails 14 may be removable from the plurality of docking pads.

Referring to FIGS. 4A and 4B; a cross-rail 14 may include a first end 40, a second end (not shown), a first stanchion 44 affixed to the first end 40, and a second stanchion (not shown) affixed to the second end. The first stanchion 44 may be constructed and arranged to be attached to the plurality of docking pads 12 via the cross-rail bolt 30. A first cut-out portion 50 may be defined by the first stanchion 44 and may allow a user to attach the cross-rail 14 to the plurality of docking pads 12 via the cross-rail bolt 30. A second cut-out portion (not shown) may be defined by the second stanchion 46 and may allow a user to attach the cross-rail 14 to the plurality of docking pads 12 via the cross-rail bolt 30.

In practice and in use, the roof of a vehicle may include a plurality of recesses defined by the roof. The plurality of recesses may be constructed and arranged to receive and attach a plurality of low-profile docking pads constructed and arranged to removably receive and attach cross-rails to complete a luggage carrier system. The plurality of docking pads may include a plurality of through holes that may receive a plurality of studs which fix the plurality of docking pads to the roof of the vehicle. A cross-rail may be removable attached to any two of the plurality of docking pads whereby a first and second stanchion of the cross-rail may be bolted to the plurality of docking pads via a cross-rail bolt in this way, a number of cross-rails may be affixed to the roof of a vehicle for carrying luggage or other cargo. When not in use, a cross-rail or plurality of cross-rails may be removed from the roof of the vehicle via the cross-rail bolt.

According to Variation 1, a product may include a luggage carrier system that may include a plurality of docking pads and at least one cross-rail wherein each individual docking pad may include a first surface and a second surface opposite the first surface and a recess portion extending from the second surface which may define a threaded hole that may be constructed and arranged to receive a cross-rail bolt. The at least one cross-rail may include a rail having a first end and a second end, a first stanchion affixed to the first end, a second stanchion affixed to the second end, and which may be constructed and arranged to be removably attached to the plurality of docking pads via the cross-rail bolt.

Variation 2 may include a product as set forth in Variation 1, wherein the plurality of docking pads may include a first docking pad and a second docking pad, the first docking pad being constructed and arranged to receive the first stanchion and the second docking pad being constructed and arranged to receive the second stanchion.

Variation 3 may include a product as set forth in Variation 2, wherein the plurality of docking pads may include a first, second, third, and fourth docking pad, the first docking pad being constructed and arranged to receive the first stanchion of a first cross-rail and the second docking pad being constructed and arranged to receive the second stanchion of the first cross-rail. Furthermore, the third docking pad may be constructed and arranged to receive the first stanchion of the second cross-rail and the fourth docking pad may be constructed and arranged to receive the second stanchion of the second cross-rail.

Variation 4 may include a product as set forth in any of Variations 1 through 3, wherein the first and second docking pads may include a corresponding first and second alignment feature which may be defined by the first surface and the first and second stanchions may include a third and fourth alignment feature corresponding to the first and second alignment feature such that when the first and second docking pads receive the first and second stanchions, the first and third alignment features may interlock and the second and fourth alignment features may interlock.

Variation 5 may include a product as set forth in any of Variations 1 through 4, wherein the plurality of docking pads may further define a plurality of through holes that may be constructed and arranged to affix the plurality of docking pads to a vehicle via a plurality of studs.

Variation 6 may include a product as set forth in any of Variations 1 through 5, wherein the plurality of docking pads may further include a plurality of gaskets disposed on the second surface of the plurality of docking pads at the plurality of through holes and at the protuberant.

Variation 7 may include a product as set forth in any of Variations 1 through 6, wherein the plurality of docking pads may further include a primary gasket disposed on the perimeter of the second surface of the plurality of docking pads.

Variation 8 may include a product as set forth in any of Variations 1 through 7, wherein the first and second stanchions may include an anti-mar material.

Variation 9 may include a product as set forth in any of Variations 1 through 8, wherein each of the first and second stanchions may define a corresponding first and second cut-out portion constructed and arranged to facilitate removable attachment of the cross-rail to the plurality of docking pads via the cross-rail bolt.

Variation 10 may include a product as set forth in any of Variations 1 through 9, wherein the first, second, third, and fourth alignment features may be generally trapezoidal in shape.

According to Variation 11, a product may include a vehicle that may include a roof that may include a plurality of roof recesses. A plurality of docking pads may be disposed within the plurality of roof recesses wherein each individual docking pad may include a first surface and a second surface opposite the first surface and a recess portion extending from the second surface and defining a threaded hole constructed and arranged to receive a cross-rail bolt. At least one cross-rail may include a rail having a first end and a second end, a first stanchion attached to the first end, a second stanchion attached to the second end, and may be constructed and arranged to be removably attached to the plurality of docking pads via the cross-rail bolt.

Variation 12 may include a product as set forth in Variation 11, wherein the plurality of docking pads may include a first docking pad and a second docking pad, wherein the first docking pad may be constructed and arranged to receive the first stanchion and the second docking pad may be constructed and arranged to receive the second stanchion.

Variation 13 may include a product as set forth in any of Variations 11 through 12, wherein the first and second docking pads may include a corresponding first and second alignment feature defined by the first surface and the first and second stanchions may include a third and fourth alignment feature corresponding to the first and second alignment feature such that when the first and second docking pads received the first and second stanchions, the first and third alignment feature interlock and the second and fourth alignment feature interlock.

Variation 14 may include a product as set forth in any of Variations 11 through 13, wherein the plurality of docking pads may define a plurality of through holes constructed and arranged to affix the plurality of docking pads to a vehicle via a plurality of studs.

Variation 15 may include a product as set forth in any of Variations 11 through 14, wherein the plurality of docking pads may further include a plurality of gaskets disposed on the second surface of the plurality of docking pads at the plurality of through holes and the recess portion.

Variation 16 may include a product as set forth in any of Variations 11 through 15, wherein the plurality of docking pads may further include a primary gasket disposed on the perimeter of the second surface of the plurality of docking pads.

Variation 17 may include a product as set forth in any of Variations 11 through 16, wherein the first and second stanchions may include an anti-mar material.

Variation 18 may include a product as set forth in any of Variations 11 through 17, wherein each of the first and second stanchions may define a corresponding first and second cut-out portion constructed and arranged to facilitate removable attachment of the cross-rail to the plurality of docking pads via the cross-rail bolt.

Variation 19 may include a product as set forth in any of Variations 11 through 18 wherein the shape of the first, second, third, and fourth alignment feature may be generally trapezoidal in shape.

According to Variation 20, a product may include a vehicle that may include a roof that may include a plurality of roof recesses. A plurality of docking pads may be disposed within the plurality of roof recesses wherein each individual docking pad may include a first and second surface opposite the first surface and a protuberant extending from the second surface which may define a threaded hole constructed and arranged to receive a cross-rail bolt and wherein the plurality of docking pads may include a first docking pad and a second docking pad, the first docking pad being constructed and arranged to receive a first stanchion and the second docking pad being constructed and arranged to receive a second stanchion. At least one cross-rail may include a rail having a first end and a second end, a first stanchion affixed to the first end, a second stanchion affixed to the second end, and which may be constructed and arranged to be removably attached to the plurality of docking pads via the cross-rail bolt and wherein the first and second docking pads may include a corresponding first and second alignment feature defined by the first surface and the first and second stanchions may include a third and fourth alignment feature corresponding to the first and second alignment feature such that when the first and second docking pads receive the first and second stanchions, the first and third alignment feature interlock and the second and fourth alignment feature interlock.

The above description of variations of the invention is merely demonstrative in nature and, thus, variations thereof are not to be regarded as a departure from the spirit and scope of the inventions disclosed within this document.

What is claimed is:

1. A product comprising:
a luggage carrier system comprising a plurality of docking pads and at least one cross-rail wherein each individual docking pad comprises a first surface and a second surface opposite the first surface and a protuberant extending from the second surface and defining a threaded hole constructed and arranged to receive a cross-rail bolt; and
wherein the at least one cross-rail comprises a rail having a first end and a second end, a first stanchion affixed to the first end, a second stanchion affixed to the second end, and is constructed and arranged to be removably attached to the plurality of docking pads via the cross-rail bolt.

2. A product as set forth in claim 1, wherein the plurality of docking pads comprises a first docking pad and a second docking pad, the first docking pad being constructed and arranged to receive the first stanchion and the second docking pad being constructed and arranged to receive the second stanchion.

3. A product as set forth in claim 2, wherein the plurality of docking pads comprises a first, second, third, and fourth docking pad, the first docking pad being constructed and arrange to receive the first stanchion of a first cross-rail and the second docking pad being constructed and arrange to receive the second stanchion of the first cross-rail and the third docking pad is constructed and arrange to receive the first stanchion of a second cross-rail and the fourth docking pad being constructed and arrange to receive the second stanchion of the second cross-rail.

4. A product as set forth in claim 2, wherein the first and second docking pads comprise a corresponding first and second alignment feature defined by the first surface and the first and second stanchions comprise a third and fourth alignment feature corresponding to the first and second alignment feature such that when the first and second docking pads receive the first and second stanchions, the first and third alignment feature interlock and the second and fourth alignment feature interlock.

5. A product as set forth in claim 1, wherein the plurality of docking pads further comprises a plurality of through holes constructed and arranged to affix the plurality of docking pads to a vehicle via a plurality of studs.

6. A product as set forth in claim 1, wherein the plurality of docking pads further comprises a plurality of gaskets disposed on the second surface of the plurality of docking pads at the plurality of through holes and the protuberant.

7. A product as set forth in claim 1, wherein the plurality of docking pads further comprises a primary gasket disposed on the perimeter of the second surface of the plurality of docking pads.

8. A product as set forth in claim 1, wherein the first and second stanchions comprise an anti-mar material.

9. A product as set forth in claim 1, wherein each of the first and second stanchions defines a corresponding first and second cut-out portion constructed and arranged to facilitate removable attachment of the cross-rail to the plurality of docking pads via the cross-rail bolt.

10. A product as set forth in claim 1, wherein the first, second, third, and fourth alignment feature are generally trapezoidal in shape.

11. A product comprising:
a vehicle comprising a roof comprising a plurality of roof recesses;
a plurality of docking pads disposed within the plurality of roof recesses wherein each individual docking pad comprises a first surface and a second surface opposite the first surface and a protuberant extending from the second surface and defining a threaded hole constructed and arranged to receive a cross-rail bolt; and
at least one cross-rail comprising a rail having a first end and a second end, a first stanchion affixed to the first end, a second stanchion affixed to the second end, and is constructed and arranged to be removably attached to the plurality of docking pads via the cross-rail bolt.

12. A product as set forth in claim 11, wherein the plurality of docking pads comprises a first docking pad and a second docking pad, the first docking pad being constructed and arrange to receive the first stanchion and the second docking pad being constructed and arrange to receive the second stanchion.

13. A product as set forth in claim 12, wherein the first and second docking pads comprise a corresponding first and second alignment feature defined by the first surface and the first and second stanchions comprise a third and fourth alignment feature corresponding to the first and second alignment feature such that when the first and second docking pads receive the first and second stanchions, the first and third alignment feature interlock and the second and fourth alignment feature interlock.

14. A product as set forth in claim 10, wherein the plurality of docking pads further comprises a plurality of through holes constructed and arranged to affix the plurality of docking pads to a vehicle via a plurality of studs.

15. A product as set forth in claim 10, wherein the plurality of docking pads further comprises a plurality of gaskets disposed on the second surface of the plurality of docking pads at the plurality of through holes and the protuberant.

16. A product as set forth in claim 10, wherein the plurality of docking pads further comprises a primary gasket disposed on the perimeter of the second surface of the plurality of docking pads.

17. A product as set forth in claim 10, wherein the first and second stanchions comprise an anti-mar material.

18. A product as set forth in claim 10, wherein each of the first and second stanchions defines a corresponding first and second cut-out portion constructed and arranged to facilitate removable attachment of the cross-rail to the plurality of docking pads via the cross-rail bolt.

19. A product as set forth in claim 10, wherein the shape of the first, second, third, and fourth alignment feature is generally trapezoidal in shape.

20. A product comprising:
a vehicle comprising a roof comprising a plurality of roof recesses;
a plurality of docking pads disposed within the plurality of roof recesses wherein each individual docking pad comprises a first surface and a second surface opposite the first surface and a protuberant extending from the second surface and defining a threaded hole constructed and arranged to receive a cross-rail bolt and wherein the plurality of docking pads comprises a first docking pad and a second docking pad, the first docking pad being constructed and arrange to receive a first stanchion and the second docking pad being constructed and arrange to receive a second stanchion; and
at least one cross-rail comprising a rail having a first end and a second end, a first stanchion affixed to the first end, a second stanchion affixed to the second end, and is constructed and arranged to be removably attached to the plurality of docking pads via the cross-rail bolt and wherein the first and second docking pads comprise a corresponding first and second alignment feature defined by the first surface and the first and second stanchions comprise a third and fourth alignment feature corresponding to the first and second alignment feature such that when the first and second docking pads receive the first and second stanchions, the first and third alignment feature interlock and the second and fourth alignment feature interlock.
